(19) United States
(12) Patent Application Publication
(10) Pub. No.: US 2024/0124796 A1
(43) Pub. Date: Apr. 18, 2024

(54) HIGH PH CO-EXTRACTION METHOD OF PREPARING A STABLE OIL BODY SOLUTION

(71) Applicant: SOCIETE DES PRODUITS NESTLE S.A., Vevey (CH)

(72) Inventors: JWANRO HUSSON, Lausanne 25 (CH); LAURENT SAGALOWICZ, Blonay (CH); OLIVIER SCHAFER, Epalinges (CH); FABIOLA DIONISI, Epalinges (CH); MARTIN ERWIN LESER, Bretigny-sur-Morrens (CH); LILIAN BARRO, La ville Aux Dames (FR)

(21) Appl. No.: 18/547,796

(22) PCT Filed: Feb. 25, 2022
(86) PCT No.: PCT/EP2022/054783

§ 371 Date: Aug. 24, 2023

(30) Foreign Application Priority Data
Feb. 26, 2021 (EP) 21159708.3

(51) Int. Cl. C11B 1/04; A23D 7/05; C11B 3/00

(52) U.S. Cl. CPC C11B 1/04; A23D 7/05; C11B 3/008

(57) ABSTRACT

The invention relates to a method of preparing an oil body solution, said method comprising the steps of a) Preparing a suspension of seed material and non-seed plant material; b) adjusting the pH of the suspension to between 6.5 to 10; c) mechanically disrupting the suspension to form a slurry; d) diluting the slurry with buffer, wherein said buffer has a pH between 6.5 to 10; and e) filtering the slurry to form an oil body solution.

### INTRODUCTION

Lipid oxidation is a strong limitation in food products generating off tastes and off flavors. Oil bodies are a natural form of lipid storage in plants mainly from seeds & nuts. They have a spherical structure, and a unique combination of proteins, lipids and phospholipids. This unique structure is protecting lipids from oxidation and it has a stable emulsion character.

Oil bodies can be used to protect polyunsaturated fatty acids (PUFAs) such as omega 3 fatty acids. Extracted plant oil bodies have relatively weak electrostatic repulsion between them which makes them physically unstable and limits their application in many foods.

Various types of components have been added to oil body preparations to improve their stabilities. Iwanaga et al, J. Agric. Food Chem. 56: 2240-2245 (2008) reported that pectin-coated oil bodies have similar or improved stability compared to uncoated oil bodies. WO 2017/066569 relates to an oil body composition containing oil bodies of different D50 size distribution from two different sources. The oil bodies are prepared separately and then combined to have the oil bodies preparation containing oil bodies of different size distribution. It is proposed to use preservatives to stabilize the oil body preparation.

A clear need exists to develop a natural, clean label stabilizing system to maintain the integrity of oil bodies for food applications.

### SUMMARY OF THE INVENTION

The inventors of the present application have developed a natural stabilizing system which maintains the integrity of oil bodies for longer periods than prior art methods. It protects against PUFA oxidization for food applications, with minimal processing. It meets consumer demand for clean label ingredient lists, and avoids the use of additives such as lecithin and maltodextrin. The invention delivers both physical and chemical stability using specific combinations of seeds and plant raw materials rich in proteins, polysaccharides and antioxidants. Particularly stable oil body solutions are obtained when the following combinations of seed and non-seed plant material are used in the method of the invention: hemp and plum; hemp and pumpkin; flax and plum; chia and lentils; and walnut and lentils.

In a first aspect, the invention relates to a method of preparing an oil body solution, said method comprising the steps of
a. Preparing a suspension comprising a seed material and a non-seed plant material;
b. Adjusting if necessary the pH of the suspension to greater than 6, preferably to between 6.5 to 10;
c. Mechanically disrupting the suspension to form a slurry;
d. Diluting the slurry with a buffer, wherein said buffer has a pH between 6.5 to 10; and
e. Filtering or centrifuging the slurry to form an oil body solution.

In a second aspect, the invention relates to an oil body solution obtained by a method as described herein, or powder thereof.

In a third aspect, the invention relates to a food product comprising an oil body solution or powder thereof as described herein.

### BRIEF DESCRIPTION OF THE FIGURES

FIG. 1: Non-homogenous chia oil body solution from Example 1

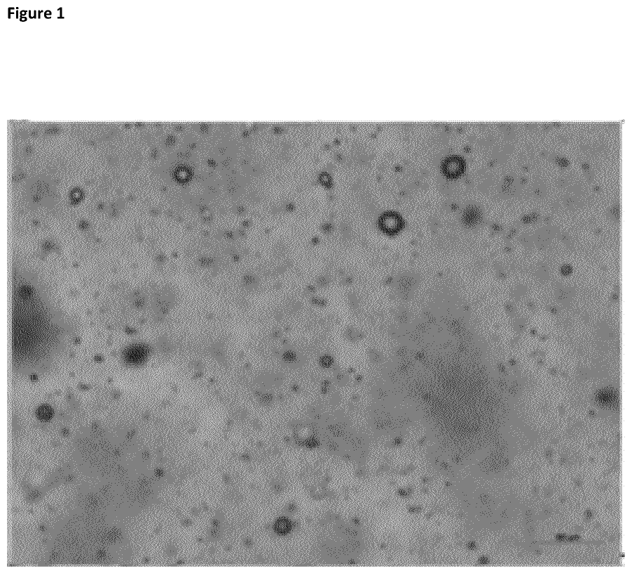

FIG. 2: Hemp oil bodies accumulated in plant materials from Example 4

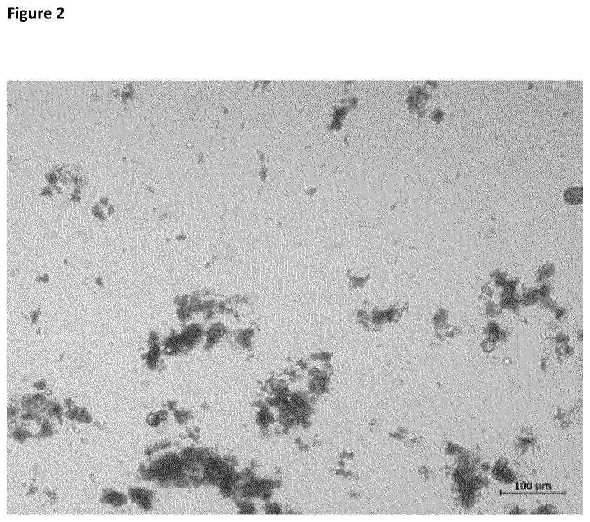

FIG. 3: Hemp oil bodies accumulated in plant materials from Example 5

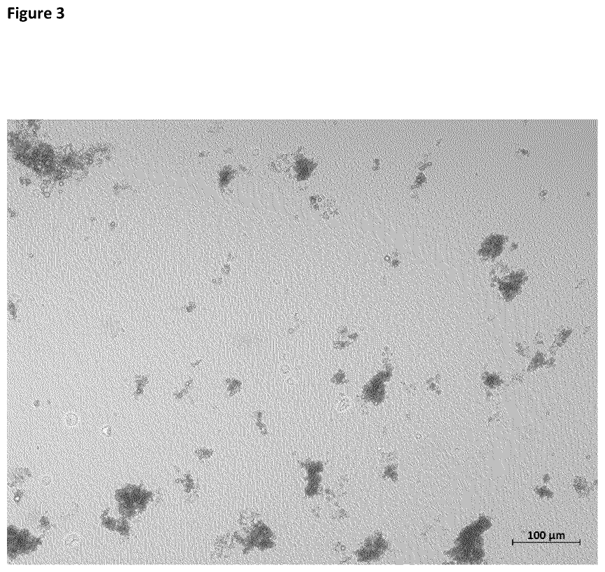

FIG. 4: Homogenous walnut oil bodies from Example 7

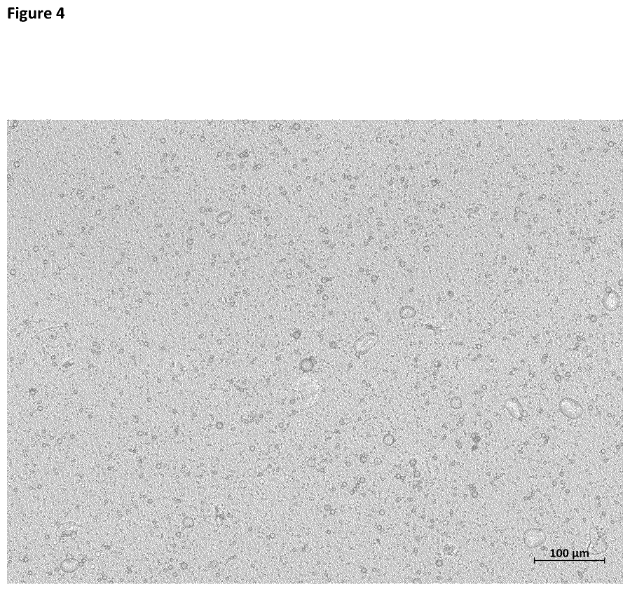

### EMBODIMENTS OF THE INVENTION

The method of the invention allows the formation of stable plant extracts in liquid and powder formulations.

In a first aspect, the invention relates to a method of preparing an oil body solution, said method comprising the steps of preparing a suspension comprising a seed material and a non-seed plant material, wherein the pH of the suspension is greater than 6, preferably between 6.5 to 10; mechanically disrupting the suspension to form a slurry; and filtering or centrifuging the slurry to form an oil body solution.

In a further aspect, the invention relates to a method of preparing an oil body solution, said method comprising the steps of preparing a suspension comprising a seed material and a non-seed plant material; adjusting the pH of the suspension to greater than 6, preferably to between 6.5 to 10; mechanically disrupting the suspension to form a slurry; and filtering or centrifuging the slurry to form an oil body solution.

In a further aspect, the invention relates to a method of preparing an oil body solution, said method comprising the steps of
a. Preparing a suspension of seed material and non-seed plant material in an aqueous phase; wherein the seed material and non-seed plant material are present in a dry weight ratio of between 50:50 to 95:5;
b. Adjusting the pH of the suspension to greater than 6, preferably to between 6.5 to 10;
c. Mechanically disrupting the suspension to form a slurry;
d. Diluting the slurry with buffer, wherein said buffer has a pH between 6.5 to 10;
e. Filtering or centrifuging the slurry to form an oil body solution; and
f. Optionally freeze drying the oil body solution to form a powder.

Preferably, the seed material and non-seed plant material are derived from different plant sources.

Certain ranges of protein and carbohydrate contents of the seed and non-seed plant material used in the process improve oil body stabilization. In some embodiments, the seed material has a protein content between 13 and 30%. In some embodiments, the seed material has a carbohydrate content between 8 and 27%. In some embodiments, the non-seed plant material has a protein content between 4 and 25%. In some embodiments, the non-seed plant material has a carbohydrate content between 16 and 35%.

In some embodiments, the total omega-3 and omega-6 content of the seed material is between 10 and 60% of its total oil content.

It has been found that specific combinations of seed and non seed or raw materials lead to improved oil body stabilization.

Preferably, the seed material is selected from the plant sources hemp, chia, flax, sunflower, sesame, watermelon, egusi, rapeseed and walnut. Preferably, the seed material is selected from the plant source hemp, flax, and chia.

In some embodiments, the non-seed plant material is selected from the plant sources pumpkin, plum, goji, jujube, aloe vera, apple, chestnut, lentil, flageolet, chickpea, mung bean, quinoa, pea, fava, kidney, black and white beans, potato peel, okra, ignames, taro, marshmallow, and mucilages from fenugreek, yellow mustard, basil, tamarin, and cresson.

Preferably, the non-seed plant material is selected from the plant sources pumpkin, plum, chestnut, lentil, flageolet, mung bean, quinoa, fava, kidney, black and white beans, okra, taro, marshmallow, and mucilages from fenugreek, yellow mustard, basil, tamarin, and cresson.

More preferably, the non-seed plant material is selected from the plant sources plum, pumpkin, or lentils. The plum is preferably fresh plum. The pumpkin is preferably fresh pumpkin.

Specific seed and non-seed plant material combinations provide particularly stable oil body solutions.

Preferably, the seed material and non-seed plant material are from the following plant source combinations:
i. Hemp and plum;
ii. Hemp and pumpkin;
iii. Flax and plum;
iv. Chia and lentils;
v. Walnut and lentils.

Most preferably, the seed material and non-seed plant material are from the following plant source combinations:
i. Hemp and plum;
ii. Hemp and pumpkin.

In one embodiment, the seed material and non-seed plant material are from flax and plum, respectively. In one embodiment, the seed material and non-seed plant material are from chia and lentils, respectively. In one embodiment, the seed material and non-seed plant material are from walnut and lentils, respectively. Preferably, the seed material and non-seed plant material are from hemp and plum, respectively. Preferably, the seed material and non-seed plant material are from hemp and pumpkin, respectively.

Preferably, the seed and non-seed plant material are present in the suspension in a ratio of about 80:20 dry weight. Preferably, the ratio of seed and non-seed plant material to buffer is about 1:6 (w/v).

The aqueous phase is preferably a buffer. The buffer may be any alkaline buffer, for example a phosphate buffer or Na₂CO₃ buffer, for example Na₂CO₃ buffer of about 0.05M. Preferably, the buffer is about pH 9.5.

Preferably, the suspension in step a) is heat treated, for example at between 85 to 105° C., for example at about 95° C., for example for about 15 mins.

Preferably, the seed and non-seed plant material are soaked, preferably for about 1 hour, preferably at room temperature.

In some embodiments, wherein lentils are the non-seed plant material, the lentils may be ground separately and added to the ground seed suspension.

The method of the invention uses a combination of blending, heat treatment, and filtration steps. The advantage over prior art methods is that the integrity of the oil bodies is maintained and the heat treatment appears to reinforce the oil body-protein-polysaccharide complexes.

In some embodiments, step a) comprises suspending the seed material and the non-seed plant material separately in a buffer at about pH 6.5 to pH 10, followed by mixing to form a suspension.

In some embodiments, the suspension in step a) is heated to between 90 to 120° C., followed by cooling to between 4 to 30° C.

In some embodiments, the suspension is cooled to between 4 to 30° C. for at least 1 hour, for example before mechanically disrupting to form a slurry.

In some embodiments, the suspension is mechanically disrupted by grinding to form a slurry.

In some embodiments, in step e) the slurry is filtered using a filter with pore size of 200 μm or less, to provide a first retentate separated from a first filtrate.

In some embodiments, i) the first retentate is added to buffer at between pH 6.5 to 10 and filtered using a filter with pore size of 200 μm or less, to provide a second retentate separated from a second filtrate; and (ii) the first filtrate and second filtrate are combined to form an oil body solution.

The oil body solution may be heat treated, for example at between 85 to 105° C., for example at about 95° C.

The invention further relates to an oil body solution, or powder thereof, for example an oil body solution obtained by a method as described herein, or powder thereof.

In some embodiments, said oil body solution has an average D [3;2] particle size between 4 μm to 26 μm measured using static light scattering,

Dx (90) μm, Dx (50) μm, and Dx (10) μm average particle sizes were also measured using static light scattering. In one embodiment, the Dx (90) μm is between 50 to 500 μm. In one embodiment, the Dx (50) μm is between 5 to 250 μm. In one embodiment, the Dx (10) μm is between 1 to 55 μm. In one embodiment, the span is between 1 to 10. Span is defined as described herein. The preferred particle sizes vary by not greater than 30% from the particle sizes shown in the examples.

Preferably, static light scattering is measured using a Mastersizer 3000. The size of all particles in the solution is measured.

The % TS (total solid) content of the oil body solutions were measured. In one embodiment, the % total solid content of the solution is less than 25%, preferably between 1 to 25%, preferably between 1 to 20%, preferably between 1 to 15%.

The invention further relates to a food product comprising an oil body solution or powder thereof as described herein, or an oil body solution or powder thereof made according to a method as described herein.

Preferably, the food product is selected from plant milks, sauces, dips, ice cream, confectionery, alternative chilled dairy, and baby food, preferably plant milk, sauces, or dips. The food product may be in a liquid form or may be in a powder form.

Preferably, the food product is a vegetarian or vegan food product.

### DETAILED DESCRIPTION OF THE INVENTION

When a composition is described herein in terms of wt % (weight percent), this means wt % of the total recipe, unless indicated otherwise.

As used herein, “about” is understood to refer to numbers in a range of numerals. In one embodiment, “about” refers to a range of −30% to +30% of the referenced number. In one embodiment, “about” refers to a range of −20% to +20% of the referenced number. In one embodiment, “about” refers to a range of −10% to +10% of the referenced number. In one embodiment, “about” refers to a range of −5% to +5% of the referenced number. In one embodiment, “about” refers to a range of −1% to +1% of the referenced number. All numerical ranges herein should be understood to include all integers, whole or fractions, within the range.

“Mechanical disruption” as described herein can be, for example, grinding, micronisation, hammer milling, or colloidal milling.

“Span” of a volume-based size distribution is defined as Span=(D90−D10)/D50. The span value gives an indication of how far the 10 percent and 90 percent points are apart, normalized with the midpoint.

The term “vegan” refers to an edible composition which is entirely devoid of animal products, or animal derived products.

The term “vegetarian” refers to an edible composition which is devoid of meat, including fish.

Typically, the seed material has a protein content between 13 and 30%. For example, chia may have a protein content from 15 to 24%, flax may have a protein content from 20 to 30%, hemp may have a protein content from 25 to 30%, and walnut may have a protein content from 13 to 18%.

Typically, the seed material has a carbohydrate content between 8 and 27%. For example, chia may have a carbohydrate content from 25 to 41%, flax may have a carbohydrate content from 25 to 28%, hemp may have a carbohydrate content from 25 to 27%, and walnut may have a protein content from 8 to 13%.

Flax is an annual plant. Flaxseeds occur in two main varietal colors: brown or yellow. Most of these varieties have similar nutritional characteristics. Flax is rich in omega-3 and other nutrients. It is a source of lignin, protein, and fibers. The flax may have a sugar content of about 1.55 g/100 g, a fat content about 37 g/100 g, an omega-3 content about 16%, an omega-6 content about 4.3%, and a saturated fat content about 3.2 g/100 g.

Chia, Salvia hispanica L., is an annual plant grown commercially for its seed, a food rich in omega-3 fatty acids. Chia genotype are numerous but mainly two varieties exist: black chia and white chia. Their composition can differ (32% oil for Tzotzol (black chia), 27% oil for Iztac II (white chia)). The fat content may be 30-34 g/100 g. The omega-3 content may be about 17%. The omega-6 content may be about 5%. The saturated fat content may be about 3.3 g/100 g.

Hemp is viewed as an eco-friendly and highly sustainable crop. The protein content may be about 30%, the oil content may be about 30%, the fiber (starch) content may be about 25%.

Typically, the non-seed plant material has a protein content between 4 and 25%. Pumpkin may have a protein content of about 10%. Plum may have a protein content of about 4%. Lentil may have a protein content of about 25%.

Typically, the non-seed plant material has a carbohydrate content between 16 and 35%. Pumpkin may have a carbohydrate content of about 25%. Plum may have a carbohydrate content of about 35%. Lentil may have a carbohydrate content of about 16%.

The following raw materials may be suited for stabilizing chia and flax oil bodies: Beans (Lentil, flageolet, chickpea, mung bean, quinoa, pea, fava, kidney, black and white beans), Legumes (Potato peel), and seeds (moringa, oat), more preferably, beans (Lentil, flageolet, mung bean, quinoa, fava), Legumes (okra), and seeds (moringa, oat). For example, lentil is particularly well suited.

The following raw materials may be suited for stabilizing hemp oil bodies: Fruits (plum, goji, jujube, aloe vera, apple, chestnut, Legumes (Pumpkin, okra, ignames, taro, marshmallow), and seeds (Fenugreek, yellow mustard, basil, tamarin, cresson), more preferably fruits (plum, chestnut, Legumes (Pumpkin, okra, taro, marshmallow), and seeds (Fenugreek, yellow mustard, basil, tamarin, cresson). For example, plum or pumpkin are particularly well suited.

The omega-3 content of the seed material is preferably between 10 and 60% of its oil content. The omega-3 content of the non-seed plant material is preferably between 10 and 60% of its oil content.

Typically, the omega-6 content of the seed material is between 15 and 65% of its oil content.

The invention relates to a method of preparing an oil body solution, said method comprising the steps of a) preparing a suspension of chia material and lentil material in an aqueous phase, preferably a buffer, wherein the chia material and lentil material are present in a dry weight ratio of between 50:50 to 95:5, preferably about 80:20; b) adjusting the pH of the suspension to between 6.5 to 10, preferably about 9.5; c) mechanically disrupting the suspension to form a slurry; d) diluting the slurry with buffer, wherein said buffer has a pH between 6.5 to 10, preferably about 9.5; e) filtering or centrifuging the slurry to form an oil body solution; and f) optionally freeze drying the oil body solution to form a powder.

The invention relates to a method of preparing an oil body solution, said method comprising the steps of a) preparing a suspension of hemp material and plum material in an aqueous phase, preferably a buffer, wherein the hemp material and plum material are present in a dry weight ratio of between 50:50 to 95:5, preferably about 80:20; b) adjusting the pH of the suspension to between 6.5 to 10, preferably about 9.5; c) mechanically disrupting the suspension to form a slurry; d) diluting the slurry with buffer, wherein said buffer has a pH between 6.5 to 10, preferably about 9.5; e) filtering or centrifuging the slurry to form an oil body solution; and f) optionally freeze drying the oil body solution to form a powder.

The invention relates to a method of preparing an oil body solution, said method comprising the steps of a) preparing a suspension of hemp material and pumpkin material in an aqueous phase, preferably a buffer, wherein the hemp material and pumpkin material are present in a dry weight ratio of between 50:50 to 95:5; b) adjusting the pH of the suspension to between 6.5 to 10; c) mechanically disrupting the suspension to form a slurry; d) diluting the slurry with buffer, wherein said buffer has a pH between 6.5 to 10; e) filtering or centrifuging the slurry to form an oil body solution; and f) optionally freeze drying the oil body solution to form a powder.

The invention relates to a method of preparing an oil body solution, said method comprising the steps of a) preparing a suspension of walnut material and lentil material in an aqueous phase, preferably a buffer, wherein the walnut material and lentil material are present in a dry weight ratio of between 50:50 to 95:5, preferably about 80:20; b) adjusting the pH of the suspension to between 6.5 to 10, preferably about 9.5; c) mechanically disrupting the suspension to form a slurry; d) diluting the slurry with buffer, wherein said buffer has a pH between 6.5 to 10, preferably about 9.5; e) filtering or centrifuging the slurry to form an oil body solution; and f) optionally freeze drying the oil body solution to form a powder.

The invention relates to a method of preparing an oil body solution, said method comprising the steps of a) preparing a suspension of flax material and plum material in an aqueous phase, preferably a buffer, wherein the flax material and plum material are present in a dry weight ratio of between 50:50 to 95:5, preferably about 80:20; b) adjusting the pH of the suspension to between 6.5 to 10, preferably about 9.5; c) mechanically disrupting the suspension to form a slurry; d) diluting the slurry with buffer, wherein said buffer has a pH between 6.5 to 10, preferably about 9.5; e) filtering or centrifuging the slurry to form an oil body solution; and f) optionally freeze drying the oil body solution to form a powder.

In step a), the temperature range used is 90 to 100° C., or 92 to 98° C., or 94 to 96° C., or about 95° C. For extraction, the temperature range used is 4° C. to 30° C., preferably about 20° C. For storage, the temperature range used is 4° C. to 12° C. The oil body solution may be freeze dried to form a powder.

The invention also relates to an oil body solution obtained by a method as described herein, or powder thereof. The oil body solution is made from seed material from the plant sources hemp, chia, flax, sunflower and walnut, and from non-seed plant material from the plant sources pumpkin, plum, goji, jujube, aloe vera, apple, chestnut, lentil, flageolet, chickpea, mung bean, quinoa, pea, fava, kidney, black and white beans, potato peel, okra, ignames, taro, marshmallow, and mucilages from fenugreek, yellow mustard, basil, tamarin, and cresson.

Preferably, the seed material and non-seed plant material are from the following plant source combinations: Chia and lentil, Hemp and plum, Hemp and pumpkin, or Walnut and lentils.

Most preferably, the seed material and non-seed plant material are from the following plant source combinations: Hemp and plum; and Hemp and pumpkin.

Preferably, the oil body solution has an average D [3;2] particle size of between 4 μm to 26 μm, measured using static light scattering. Preferably, the solution has a pH between 6.5 to 10.

In one embodiment, the Dx (90) μm is between 50 to 500 μm. In one embodiment, the Dx (50) μm is between 5 to 250 μm. In one embodiment, the Dx (10) μm is between 1 to 55 μm. In one embodiment, the span is between 1 to 10. Span is defined as described herein. The preferred particle sizes for a given solution should vary by not greater than 30% from the D [3;2] particle sizes shown in the examples.

In one embodiment, the oil body cream is transformed into a fermented plant based product, for example a yogurt alternative. In one embodiment, a plant composition comprising the oil body cream or the oil body cream itself is added with at least one bacterial culture to form a fermentable mixture. The bacterial culture may comprise one or several lactic acid-producing bacteria. The fermentable mixture is maintained, for example at 45° C., for example between 4 to 6 hours.

The invention also relates to a food product comprising an oil body solution or powder as described herein. Preferably, the food products are selected from plant milks, sauces, dips, ice cream, confectionery, alternative chilled dairy, and baby food, preferably plant milk, alternative chilled dairy, sauces, or dips. The alternative chilled dairy may be preferably yogurt analogues. The food product may be in a liquid form or may be in a powder form.

### EXAMPLES

### Example 1: Production of Oil Body Solution from Chia Seeds

Seeds were suspended in 0.05M Na₂CO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 4° C. or freeze-dried and the resulting powder stored at 4° C.

| | T 0 | T 2 (6 weeks) |
|---|---|---|
| Phase separation | No phase separation | No phase separation |
| Smell | No fishy smell | Fishy smell |

### Example 2: Production of Oil Body Solution from Chia and Lentils

Seeds were suspended in 0.05M Na₂CO₃ buffer at pH 9.5 (adjusted with 1M HCl), (ratio 1:6, w/v) and heat treated at 95° C. for 15 min in a water bath. After they were soaked for 1 hour at room temperature, the resulting slurry was ground for 30 s using a Waring blender at speed 1 (1800 rpm) (Waring Blendor, USA). Lentils previously ground (Retch GM200, Germany) and sieved <500 μm (Retch GM200 Jet, Germany) were added to the ground seed solution (in a ratio 20:80, w/w, lentils/chia seeds). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, it was stored at 4° C. or freeze-dried and the resulting powder stored at 4° C.

| | T 0 | T 2 (11 weeks) |
|---|---|---|
| Phase separation | No phase separation | No phase separation |
| Smell | No fishy smell | Early fishy smell |

### Example 3: Production of Oil Body Solution from Hemp Seeds

Seeds were suspended in 0.05M NaCO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 40° C. or freeze-dried and the resulting powder stored at 4° C.

| | T 0 | T 2 (6 weeks) |
|---|---|---|
| Phase separation | No phase separation | Decantation |
| Smell | No fishy smell | Strong fishy smell |

### Example 4: Production of Oil Body Solution from Hemp and Plum

80 g hemp+33 g fresh plum (60% dry matter, total dry matter from 33 g fresh plum: 20 g, giving ratio 80:20) were suspended in 0.05M NaCO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 40° C. or freeze-dried and the resulting powder stored at 4° C.

| | T 0 | T 4 (17 weeks) |
|---|---|---|
| Phase separation | No phase separation | Decantation |
| Smell | No fishy smell | No fishy smell |

### Example 5: Production of Oil Body Solution from Hemp and Pumpkin

80 g hemp+200 g fresh pumpkin (10% dry matter, total dry matter from 200 g fresh pumpkin: 20 g, giving a ratio 80:20) were suspended in 0.05M NaCO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. The oil body particle size D [3;2] was 4.06 μm, measured using static light scattering. Finally, the final oil body solution was stored at 40° C. or freeze-dried and the resulting powder stored at 4° C.

| | T 0 | T 4 (17 weeks) |
|---|---|---|
| Phase separation | No phase separation | Decantation |
| Smell | No fishy smell | No fishy smell |

### Example 6: Production of Oil Body Solution from Flax Seeds

Seeds were suspended in 0.05M NaCO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 40° C. or freeze-dried and the resulting powder stored at 4° C.

| | T 0 | T 2 (8 weeks) |
|---|---|---|
| Phase separation | No phase separation | Decantation |
| Smell | No fishy smell | Fishy smell |

### Example 7: Production of Oil Body Solution from Flax and Plum

80 g hemp+33 g fresh plum (60% dry matter, total dry matter from 33 g fresh plum: 20 g, giving ratio 80:20) were suspended in 0.05M NaCO₃ buffer at pH 9.5 (adjusted with 1M HCl), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). Na₂CO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. The solution had a larger average size than the solutions from the other examples. This was likely due to oil body aggregation. Finally, the final oil body solution was stored at 40° C. or freeze-dried and the resulting powder stored at 4° C.

| | T 0 | T 2 (8 weeks) |
|---|---|---|
| Phase separation | No phase separation | Decantation |
| Smell | No fishy smell | No fishy smell |

### Example 8: Production of Oil Body Solution from Walnut

Walnuts were suspended in 0.05M NaCO₃ buffer at pH 9.5 (adjusted with 1M HCl), (ratio 1:6, w/v) and heat treated at 95° C. for 15 min in a water bath. Then they were soaked for 1 hours at room temperature. The resulting slurry was ground for 30 s using a Waring blender at speed 1 (1800 rpm) (Waring Blendor, USA). NaCO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 40° C. or freeze-dried and the resulting powder stored at 4° C.

| | T 0 | T 2 (8 weeks) |
|---|---|---|
| Phase separation | Decantation | Decantation |
| Smell | No fishy smell | Strong fishy smell |

### Example 9: Production of Oil Body Solution from Walnut and Lentils

Walnuts were suspended in 0.05M NaCO₃ buffer at pH 9.5 (adjusted with 1M HCl), (ratio 1:6, w/v) and heat treated at 95° C. for 15 min in a water bath. Then they were soaked for 1 hours at room temperature. The resulting slurry was ground for 30 s using a Waring blender at speed 1 (1800 rpm) (Waring Blendor, USA). Lentils previously ground (Retch GM200, Germany) and sieved <500 μm (Retch GM200 Jet, Germany) were added to ground seed solution (in ratio 20:80, w/w, lentils/walnut seeds). NaCO₃ buffer at pH 9.5 was added to reach a 1:10 w/v. The mixture was mixed at room temperature for 1 hour with a Heidolph overhead mixer (RZR 2021, Germany) then filtered using a 200 μm-pore size cheesecloth. The retentate was extracted again as above, i.e. mixed with Na₂CO₃ buffer (ratio 1:4, w/v) at room temperature for 30 min then filtered. The two filtrates were grouped to get the final oil body solution. The final oil body solution was heat-treated at 95° C. for 10 min in a water bath before to be let stand at room temperature. Finally, the final oil body solution was stored at 40° C. or freeze-dried and the resulting powder stored at 4° C.

| | T 0 | T 2 (12 weeks) |
|---|---|---|
| Phase separation | No phase separation | Decantation |
| Smell | No fishy smell | No fishy smell |

### Example 10: Production of Oil Body Solution from Hemp and Pumpkin with Slurry Recycling

Hemp seeds and pumpkin (ratio 80:20) were suspended in milli-Q water at pH 6.5 (adjusted with 1M HCL), (ratio 1:6, w/v) and heat treated at 95° C. for 15 min in a water bath. Then they were soaked for 1 hour at room temperature. The resulting slurry was ground for 30 s using a Waring blender at speed 1 (1800 rpm) (Waring Blendor, USA). The mixture was mixed at room temperature for 1 hour with a Heidolph overhead mixer (RZR 2021, Germany) then filtered using a 200 μm-pore size cheesecloth. The oil body solution was heat-treated at 95° C. for 10 min in a water bath before to be let stand at room temperature. The slurry was ground for 10 seconds using a Retsch GM200, the slurry was then mixed with the oil body solution at different ratios for example at 1:5 ratio (slurry:oil body solution). Finally, the mixture was either stored at 4° C. or freeze-dried and the resulting powder stored at 4° C.

### Example 11: TS Content and Particle Size Measurements

The oil body solutions had the following measured total solid contents:

| | |
|---|---|
| Chia Milk | 4.1% |
| Flax Milk | 1.7% |
| Flax-Plum Milk | 3.6% |
| Walnut Milk | 10.2% |
| Walnut-Lentils Milk | 12.2% |
| OB Milk Hemp | 18.7% |

The following particle size measurements were recorded with a Mastersizer 3000 from Malvern (No SDS, RI 1.54 & abs. index 0.01, and dispersant water RI 1.33).

| | | | Flax | | Walnut | OB |
|---|---|---|---|---|---|---|
| | Chia | Flax | Plum | Walnut | Lentils | Milk |
| Sample Name | Milk | Milk | Milk | Milk | Milk | Hemp |
| D [4; 3] μm | 203 | 159 | 244 | 25.8 | 32.5 | 369 |
| D [3; 2] μm | 26 | 12.5 | 57.4 | 5.03 | 6.86 | 15.2 |
| Span | 2.507 | 3.179 | 2.117 | 5.022 | 8.276 | 2.36 |
| Dx (90) μm | 440 | 373 | 480 | 47.1 | 100 | 764 |
| Dx (50) μm | 171 | 116 | 202 | 8.96 | 11.8 | 323 |
| Dx (10) μm | 11.1 | 3.53 | 51.7 | 2.1 | 2.91 | 3.31 |

1. A method of preparing an oil body solution, said method comprising the steps of
a. preparing a suspension of seed material and non-seed plant material in an aqueous phase, wherein the seed material and non-seed plant material are present in a dry weight ratio of between 50:50 to 95:5;
b. adjusting the pH of the suspension to greater than 6;
c. mechanically disrupting the suspension to form a slurry;
d. diluting the slurry with buffer, wherein said buffer has a pH between 6.5 to 10; and
e. filtering or centrifuging the slurry to form an oil body solution.

2. The method according to claim 1, wherein the seed material has a protein content between 13 and 30% and a carbohydrate content between 8 and 27%, and the non-seed plant material has a protein content between 4 and 25% and a carbohydrate content between 16 and 35%.

3. The method of claim 1, wherein the omega-3 content of the seed material is between 10 and 60% of its oil content.

4. The method of claim 1, wherein the seed material and non-seed plant material are selected from the following plant source combinations:
a. Hemp and plum;
b. Hemp and pumpkin;
c. Chia and lentil;
d. Flax and plum; and
e. Walnut and lentil.

5. The method of claim 1, wherein step a) comprises suspending the seed material and the non-seed plant material separately in a buffer at about pH 6.5 to pH 10, followed by mixing to form a suspension.

6. The method of claim 1, wherein the suspension in step a) is heated to between 90 to 120° C., followed by cooling to between 4 to 30° C.

7. The method of claim 1, wherein the suspension is cooled to between 4 to 30° C. for at least 1 hour.

8. The method of claim 1, wherein the suspension is mechanically disrupted by grinding to form a slurry.

9. The method of claim 1, wherein (i) the slurry is filtered using a filter with pore size of 200 μm or less, to provide a first retentate separated from a first filtrate.

10. The method of claim 9, wherein (i) the first retentate is added to buffer at between pH 6.5 to 10 and filtered using a filter with pore size of 200 μm or less, to provide a second retentate separated from a second filtrate; and (ii) the first filtrate and second filtrate are combined to form an oil body solution.

11. The method of claim 1, wherein the average D [3;2] particle size of the oil bodies in solution in step e) after filtering or centrifuging is between 4 μm to 26 μm, measured using static light scattering.

12. The method of claim 1, wherein the % total solid content of the oil body solution is between 1 to 15%.

13. (canceled)

14. An oil body solution, wherein said solution has an average D [3;2] particle size between 4 μm to 26 μm, measured using static light scattering, and wherein said solution has a pH between 6.5 to 10.

15. Food product comprising an oil body solution, wherein said solution has an average D [3;2] particle size between 4 μm to 26 μm, measured using static light scattering, and wherein said solution has a pH between 6.5 to 10, wherein said food product is selected from the group consisting of a plant milk, alternative chilled dairy, sauce, and dip.
